(19) United States
(12) Patent Application Publication
(10) Pub. No.: US 2019/0318850 A1
(43) Pub. Date: Oct. 17, 2019

(54) BRAID PROCESSING DEVICE AND METHOD FOR PROCESSING BRAIDED CABLE

(71) Applicant: SUMITOMO WIRING SYSTEMS, LTD., Mie (JP)

(72) Inventors: Riki OGINO, Mie (JP); Junichi SHIRAKAWA, Mie (JP)

(73) Assignee: SUMITOMO WIRING SYSTEMS, LTD., Mie (JP)

(21) Appl. No.: 16/475,523

(22) PCT Filed: Apr. 17, 2018
(86) PCT No.: PCT/JP2018/015830

§ 371 Date: Jul. 2, 2019

(30) Foreign Application Priority Data
Apr. 26, 2017 (JP) 2017-086885

(51) Int. Cl. H01B 13/00; H01R 43/28; H02G 1/12

(52) U.S. Cl. CPC H01B 13/0006; H01B 13/0003; H02G 1/1248; H01R 43/28

(57) ABSTRACT

A braid processing device trims an end portion of an exposed braid of a braid-shielded cable including a cable center portion (e.g., two insulated wires), a braid that covers an outer circumferential surface of the cable center portion, and a sheath that covers an outer circumferential surface of the braid, the exposed braid being exposed from the sheath. The braid processing device includes a braid raising mechanism that raises the exposed braid from the cable center portion toward an outer circumferential side, and a shearing mechanism. The shearing mechanism includes an outer blade that has an annular outer cutting edge, an inner blade that has an annular inner cutting edge, the annular outer cutting edge and the annular inner cutting edge being capable of shearing the exposed braid therebetween, and a blade driving portion that relatively moves the inner blade toward the annular outer cutting edge.

### TECHNICAL FIELD

The present invention relates to a technology for trimming an end portion of a braid of a braid-shielded cable.

### BACKGROUND ART

Patent Document 1 discloses a technology for crimping a terminal to an end portion of a cable equipped with a braid. The terminal is also crimped onto the braid that is exposed at the end portion of the cable.

### CITATION LIST

### Patent Documents

Patent Document 1: JP 2010-153046A

### SUMMARY OF INVENTION

### Technical Problem

When a terminal is to be crimped onto a braid exposed at an end portion of a cable, the braid is exposed on the outer circumferential surface of an internal insulator at the end portion of the cable, or is exposed on the outer circumferential surface of an external sheath in a state in which the braid is inverted.

In either case, there is a risk that if an end portion of the exposed braid is uneven, metal strands constituting the braid will protrude unevenly from the crimped portion.

Therefore, it is an object of the present invention to make it possible to trim an end portion of a braid of a braid-shielded cable as accurately as possible.

### Solution to Problem

To address the above-described problem, a first aspect of the invention is a braid processing device for trimming an end portion of an exposed braid of a braid-shielded cable including a cable center portion, a braid that covers an outer circumferential surface of the cable center portion, and a sheath that covers an outer circumferential surface of the braid, the exposed braid being exposed from the sheath, the braid processing device including: a braid raising mechanism that raises the exposed braid from the cable center portion toward an outer circumferential side; and a shearing mechanism including an outer blade that has an annular outer cutting edge having an inner diameter that is larger than an outer diameter of the cable center portion, an inner blade that has an insertion space into which the cable center portion can be inserted and that has an annular inner cutting edge on an outer circumferential portion thereof, the annular outer cutting edge and the annular inner cutting edge being capable of shearing the exposed braid therebetween, and a blade driving portion that relatively moves the inner blade toward the annular outer cutting edge in a state in which one of main surfaces of the exposed braid that has been raised from the cable center portion toward the outer circumferential side is in contact with the annular outer cutting edge around the cable center portion.

A second aspect of the invention is the braid processing device according to the first aspect, wherein the braid raising mechanism includes a pressing and raising mechanism that presses the exposed braid from the outer circumferential side toward the cable center portion and thereby raises the exposed braid.

A third aspect of the invention is the braid processing device according to the second aspect, wherein the pressing and raising mechanism includes a rolling body that is supported so as to be rotatable about an axis extending in an axial direction of the cable center portion, a rolling body contacting and separating mechanism that moves the rolling body toward and away from the cable center portion, and a rolling body turning mechanism that turns the rolling body around the cable center portion. A fourth aspect of the invention is the braid processing device according to the third aspect, including a moving mechanism that relatively moves the rolling body from a leading end portion toward a base end portion of the exposed braid in a state in which the rolling body rotates while pressing the exposed braid.

A fifth aspect of the invention is the braid processing device according to any one of the first to fourth aspects, wherein the braid raising mechanism includes a sandwiching and raising mechanism including a raising annular member that enters between the cable center portion and the exposed braid and raises the exposed braid and a raising annular receiving member that sandwiches the exposed braid between the raising annular receiving member and the raising annular member on the outer circumferential side of the cable center portion.

A sixth aspect of the invention is the braid processing device according to any one of the first to fifth aspects, including a cover portion that covers at least both lateral sides of four sides of a portion to be sheared off of the exposed braid between the annular outer cutting edge and the annular inner cutting edge.

A seventh aspect of the invention is the braid processing device according to the sixth aspect, wherein the outer blade surrounds the portion to be sheared off together with the cover portion.

An eighth aspect of the invention is the braid processing device according to the sixth or seventh aspect, further including an air stream generating portion that generates a stream of air within the cover portion.

A ninth aspect of the invention is the braid processing device according to any one of the first to eighth aspects, further including an inverting mechanism including an inverting member in which an inverting hole into which the sheath can be inserted is formed, the inverting mechanism inverting the exposed braid that has been raised from the cable center portion toward the outer circumferential side and whose end portion has been sheared off, by forcing the exposed braid toward the outer circumferential side of the sheath using the inverting member.

A tenth aspect of the invention is the braid processing device according to any one of the first to eighth aspects, wherein the inner blade inverts the exposed braid that has been raised from the cable center portion toward the outer circumferential side and whose end portion has been sheared off, by forcing the exposed braid toward the outer circumferential side of the sheath from a side opposite to the sheath.

An eleventh aspect of the invention is a method for processing a braid-shielded cable using the braid processing device according to any one of the first to tenth aspects, the method including: raising the exposed braid from the cable center portion toward the outer circumferential side using the braid raising mechanism; and trimming the exposed braid by relatively moving the inner blade toward the annular outer cutting edge in a state in which the outer blade is disposed so that the annular outer cutting edge is in contact with one of main surfaces of the exposed braid that has been raised from the cable center portion toward the outer circumferential side, around the cable center portion.

### Advantageous Effects of Invention

According to the first aspect, when the inner blade is relatively moved toward the annular outer cutting edge in a state in which one of the main surfaces of the exposed braid that has been raised from the cable center portion toward the outer circumferential side is in contact with the annular outer cutting edge around the cable center portion, the exposed braid is sheared off between the annular inner cutting edge and the annular outer cutting edge around the cable center portion. Therefore, the end portion of the braid of the braid-shielded cable can be trimmed as accurately as possible.

According to the second aspect, since the braid raising mechanism includes the pressing and raising mechanism, which presses the exposed braid from the outer circumferential side toward the cable center portion and thereby raises the exposed braid, the exposed braid can be easily raised even in the case where the exposed braid extends along the outer circumferential surface of the cable center portion.

According to the third aspect, it is possible to repeatedly press the exposed braid with the rolling body by moving the rolling body toward and away from the cable center portion using the rolling body contacting and separating mechanism, and thus, the exposed braid can be effectively raised. Moreover, it is possible to uniformly raise the exposed braid around the cable center portion by turning the rolling body around the cable center portion using the rolling body turning mechanism. When the rolling body presses the exposed braid, the rolling body can be driven to rotate while abutting against the exposed braid, and therefore the rolling body can be continuously turned without stopping turning.

According to the fourth aspect, since the rolling body can be relatively moved from the leading end portion to the base end portion of the exposed braid, a large region of the exposed braid spanning from the leading end portion to the base end portion thereof can be raised, and therefore, the exposed braid can be more reliably raised.

According to the fifth aspect, it is possible to even more reliably raise the exposed braid by raising the exposed braid using the raising annular member and sandwiching the exposed braid between the raising annular member and the raising receiving member.

According to the sixth aspect, since at least both lateral sides of the four sides of the portion to be sheared off are covered by the cover portion, dust that is produced during shearing is unlikely to spread to the surrounding region.

According to the seventh aspect, since the outer blade surrounds the portion to be sheared off together with the cover portion, the portion to be sheared off can be surrounded with a configuration that is as simple as possible.

According to the eighth aspect, the stream of air generated within the cover portion can make it unlikely that the shear dust will spread to the surrounding region.

According to the ninth aspect, the trimmed exposed braid can be inverted so as to cover the outer circumferential side of the sheath.

According to the tenth aspect, the trimmed exposed braid can be inverted by the inner blade so as to cover the outer circumferential side of the sheath.

According to the eleventh aspect, when the inner blade is relatively moved toward the annular outer cutting edge in a state in which one of the main surfaces of the exposed braid that has been raised from the cable center portion toward the outer circumferential side is in contact with the annular outer cutting edge around the cable center portion, the exposed braid is sheared off between the annular inner cutting edge and the annular outer cutting edge around the cable center portion. Therefore, the end portion of the braid of the braid-shielded cable can be trimmed as accurately as possible.

### BRIEF DESCRIPTION OF DRAWINGS

FIG. 1 is a schematic cross-sectional view showing a state in which a terminal is attached to an end portion of a braid-shielded cable.

FIG. 2 is a schematic cross-sectional view showing a state in which an exposed braid at the end portion of the braid-shielded cable is inverted.

FIG. 3 is a schematic diagram showing an overall configuration of a braid processing device.

FIG. 4 is a schematic perspective view showing a braid raising mechanism.

FIG. 5 is an explanatory diagram illustrating an operation of the braid raising mechanism.

FIG. 6 is an explanatory diagram illustrating an operation of the braid raising mechanism.

FIG. 7 is an explanatory diagram illustrating an operation of the braid raising mechanism.

FIG. 8 is an explanatory diagram illustrating an operation of the braid raising mechanism.

FIG. 9 is an explanatory diagram illustrating an operation of the braid raising mechanism.

FIG. 10 is an explanatory diagram illustrating an operation of the braid raising mechanism.

FIG. 11 is an explanatory diagram illustrating an operation of the braid raising mechanism.

FIG. 12 is an explanatory diagram illustrating an operation of the braid raising mechanism.

FIG. 13 is a schematic perspective view showing a shearing mechanism.

FIG. 14 is an explanatory diagram illustrating an operation of the shearing mechanism.

FIG. 15 is an explanatory diagram illustrating an operation of the shearing mechanism.

FIG. 16 is an explanatory diagram illustrating an operation of the shearing mechanism.

FIG. 17 is an explanatory diagram illustrating an operation of the shearing mechanism.

FIG. 18 is an explanatory diagram illustrating an operation of the shearing mechanism.

FIG. 19 is a schematic perspective view showing an inverting mechanism.

FIG. 20 is an explanatory diagram illustrating an operation of the inverting mechanism.

FIG. 21 an explanatory diagram illustrating an operation of the inverting mechanism.

FIG. 22 an explanatory diagram illustrating an operation of the inverting mechanism.

FIG. 23 is an explanatory diagram illustrating an inner blade according to a modification.

FIG. 24 is an explanatory diagram illustrating an inner blade according to a modification.

### DESCRIPTION OF EMBODIMENTS

Hereinafter, a braid processing device and a method for processing a braid-shielded cable according to embodiments of the invention will be described.

### Braid-Shielded Cable

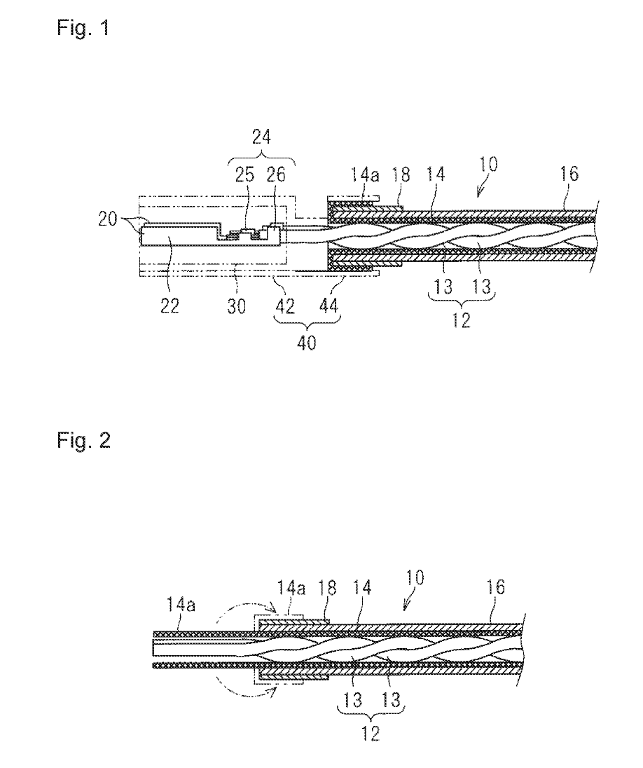

For the sake of convenience of description, a braid-shielded cable to be processed will be described. FIG. 1 is a schematic cross-sectional view showing a state in which a terminal is attached to an end portion of a braid-shielded cable 10.

The braid-shielded cable 10 is, for example, a twisted wire for use in a vehicle, which serves as a component of a wire harness installed in a vehicle such as an automobile. Specifically, the braid-shielded cable 10 includes a stranded portion 12 serving as a cable center portion, a braid 14 that covers the outer circumferential surface of the stranded portion 12, and a sheath 16 that covers the outer circumferential surface of the braid 14.

The stranded portion 12 is configured by a plurality of (two, here) insulated wires 13 twisted together. Each insulated wire 13 has a core wire 13a, which is a linear conductor, and an insulating coating 13b that covers the circumferential surface of the core wire 13a. The insulating coatings 13b are primary coatings that individually cover the respective core wires 13a inside the sheath 16. Each core wire 13a is configured by, for example, a stranded wire constituted by a plurality of conductive strands twisted together. However, it is also conceivable that the core wires are solid wires.

The two insulated wires 13 are twisted together to be coaxially helically wound around each other. The center line of the braid-shielded cable 10 is the axis of the helixes formed by the respective insulated wires 13. Terminals 20 are crimped onto end portions of the two insulated wires 13.

The braid 14 is a shielding layer that covers the outer circumferential surface of the stranded portion 12. The braid 14 is formed by braiding metal strands made of copper, a copper alloy, or the like into a tubular shape. This braid 14 has a tubular shape that covers the stranded portion 12 on the inner circumferential side of the sheath 16, but in a state in which the braid is exposed from the sheath, the braid can be deformed so as to expand in diameter in such a manner that the size of the meshes increase.

The sheath 16 is an insulator formed by extrusion molding a resin on the outer circumferential surface of the braid 14. The sheath 16 on the outer circumferential surface of the braid 14 keeps the plurality of insulated wires 13 in a bundled state and keeps the tubular shape of the braid 14.

The above-described braid-shielded cable 10 can be applied to a cable for high-speed communication that is in conformity with the Ethernet (registered trademark) standard.

However, the braid-shielded cable 10 need not have the above-described configuration.

The cable center portion may include only a single wire, or may include three or more wires. In the cable center portion, a plurality of wires may also be bundled in a state in which the wires are arranged in parallel, instead of being twisted together. An insulating layer may also be disposed between the stranded portion 12 and the braid 14. The braid-shielded cable may also be a so-called coaxial cable in which an internal insulating layer is formed around a center conductor, a braid is formed around the internal insulating layer, and a sheath is formed around the braid.

At an end portion of the braid-shielded cable 10, the sheath 16 is partially stripped away to expose the two insulated wires 13. Furthermore, at end portions of the two insulated wires 13, the insulating coatings 13b are stripped away to expose the core wires 13a.

Each terminal 20 is formed by appropriately performing pressing or other processing on a metal plate material made of copper, a copper alloy, or the like. A plating layer made of tin, nickel, or the like may also be formed on the surface of the terminal 20. The terminal 20 is formed into a shape in which a mating-device-connecting portion 22 and a wire connecting portion 24 are contiguously arranged in a straight line.

The mating-device-connecting portion 22 is a portion that is to be connected to a mating terminal or the like. Here, the mating-device-connecting portion 22 is formed into a box-like shape, that is, the shape of a so-called female terminal, as a whole. Moreover, a mating terminal (so-called male terminal) having a pin- or tab⁻shaped connecting portion is inserted into and connected to this mating-device-connecting portion 22. However, the mating-device-connecting portion 22 may also be formed into a pin- or tab-like shape, that is, the shape of a so-called male terminal. In the male terminal as well, a box portion is provided at a pin- or tab-shaped base end portion.

The wire connecting portion 24 is a portion that is crimped onto the end portion of the corresponding insulated wire 13 and connected to the insulated wire 13. Here, the wire connecting portion 24 includes a core wire barrel portion 25 and a coating barrel portion 26. However, the coating barrel portion 26 may be omitted from the wire connecting portion 24.

The core wire barrel portion 25 is formed into a shape in which a pair of core wire crimp pieces extend upward from both side portions of a bottom plate portion, and, in a state in which the exposed core wire 13a is disposed therein, the pair of core wire crimp pieces are bent inward. Thus, the core wire barrel portion 25 is crimped onto the exposed core wire 13a.

The coating barrel portion 26 is formed into a shape in which a pair of coating crimp pieces extend upward from both side portions of the bottom plate portion, and, in a state in which an end portion of the insulating coating 13b is disposed therein, the pair of coating crimp pieces are bent inward. Thus, the coating barrel portion 26 is crimped onto the end portion of the insulating coating 13b.

The terminals 20 are respectively crimped onto the end portions of the two insulated wires 13. The two terminals are accommodated in a dielectric case 30 made of a resin or the like. The dielectric case 30 separates the two terminals 20 so that the terminals do not come into direct contact with each other, and covers the outer peripheries thereof. Two openings corresponding to the two terminals 20 are formed on a leading end side of the dielectric case 30. Two terminals of a mating device can be inserted into the two openings, respectively, and connected to the corresponding terminals 20.

Moreover, the outer periphery of the dielectric case 30 is covered by an outer conductor terminal 40. The outer conductor terminal 40 is formed by appropriately performing pressing or other processing on a metal plate material made of copper, a copper alloy, or the like. A plating layer made of tin, nickel, or the like may also be formed on the surface of the outer conductor terminal 40. The outer conductor terminal 40 is formed into a shape in which a dielectric case accommodating portion 42 and a braid crimp portion 44 are contiguously arranged in a straight line.

The dielectric case accommodating portion 42 is formed into a box shape, and configured to be able to accommodate the outer periphery of the dielectric case 30 inside.

The braid crimp portion 44 extends from one end portion of the dielectric case accommodating portion 42 toward the end portion of the sheath 16. The braid crimp portion 44 is, for example, formed into a shape in which a pair of braid crimp pieces extend upward from both side portions of a bottom plate portion. Moreover, a portion (hereinafter also referred to as an “exposed braid 14a”) of the braid 14 that is exposed from the end portion of the sheath 16 is inverted so as to cover the end portion of the sheath 16. Here, a metal sleeve 18 covers the outer circumferential surface of the sheath 16, and the exposed braid 14a covers the outer circumferential surface of the metal sleeve 18. The metal sleeve 18 may be omitted. Moreover, the end portion of the sheath 16, the metal sleeve 18, and the exposed braid 14a covering the outer circumferential surface of the metal sleeve 18 are disposed in the braid crimp portion 44, and in this state, the pair of braid crimp pieces are bent inward. Thus, the braid crimp portion 44 is crimped onto the end portion of the sheath 16, the metal sleeve 18, and the exposed braid 14a. Since the braid crimp portion 44 is in contact with the exposed braid 14a on the outer circumferential surface of the end portion of the sheath 16, the braid crimp portion 44 is kept in electrical contact with the braid 14. The metal sleeve 18 may also be omitted, and the exposed braid 14a be inverted so as to come into contact with the outer circumferential surface of the end portion of the sheath 16.

Although a configuration in which the outer conductor terminal 40 is crimped onto the exposed braid 14a has been described here, a configuration is also conceivable in which another metal ring for ground connection is crimped onto the exposed braid 14a.

In order to invert the end portion of the exposed braid 14a onto the outer circumferential surface of the sheath 16 as described above, as shown in FIG. 2, the sheath 16 is partially removed from the end portion of the braid-shielded cable 10 to expose the braid 14, and then, the exposed braid 14a is inverted.

In order to prevent a leading end portion of the exposed braid 14a from protruding unevenly from the braid crimp portion 44 in a state in which the exposed braid 14a has been inverted and the braid crimp portion 44 has been crimped onto this exposed braid 14a, it is necessary to trim the leading end portion of the exposed braid 14a.

The braid processing device and the method for processing a braid-shielded cable according to the present invention relate to a technology for trimming the leading end portion of the exposed braid 14a exposed from the sheath 16.

### Overall Configuration of Braid Processing Device

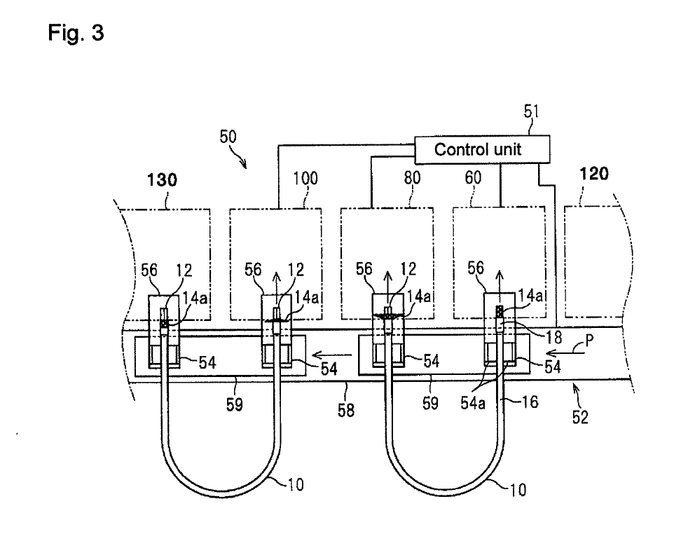

FIG. 3 is a schematic diagram showing an overall configuration of a braid processing device 50. The braid processing device 50 includes a cable end portion conveying mechanism 52, a braid raising mechanism 60, a shearing mechanism 80, and an inverting mechanism 100.

The cable end portion conveying mechanism 52 conveys both end portions of a cut length of the braid-shielded cable 10 in a conveying direction P. The braid raising mechanism 60, the shearing mechanism 80, and the inverting mechanism 100 are provided in this order from an upstream side toward a downstream side along the conveying direction P.

A preprocessing mechanism 120 including a metal sleeve external-fitting mechanism for externally fitting the metal sleeve 18 to the sheath 16 and a sheath stripping device for partially stripping away the sheath 16 from each of the two end portions of the braid-shielded cable 10, and the like is provided upstream of the braid raising mechanism 60. Therefore, at the two end portions of the braid-shielded cable 10 conveyed toward the braid raising mechanism 60, the sheath 16 has been removed and the exposed braid 14a is exposed at the portions where the sheath 16 has been removed, and the metal sleeves 18 are externally fitted to the respective end portions of the sheath 16. The above-described preprocessing mechanism 120 may also be omitted, and the end portions of the braid-shielded cable 10 with respect to which operations for removing the sheath 16, externally fitting the metal sleeves 18, and the like have been performed manually be set in the cable end portion conveying mechanism 52.

In addition, a postprocessing mechanism 130 including a stripping device for stripping away the insulating coatings 13b from end portions of the insulated wires 13, a terminal crimping device for crimping a terminal, and the like is provided downstream of the braid raising mechanism 60. Thus, after the end portions of the braid-shielded cable 10 have been subjected to processing such as trimming the exposed braid 14a, inverting the exposed braid 14a, and the like, processing such as stripping away the insulating coatings 13b of the insulated wires 13, crimping the terminals, and the like is automatically performed. It goes without saying that the postprocessing mechanism 130 may also be omitted, and processing such as stripping away the insulating coatings 13b of the insulated wires 13, crimping the terminals, and the like be performed manually. An operation for attaching the above-described dielectric case 30, an operation for crimping the outer conductor terminal 40, and the like can also be performed manually.

The cable end portion conveying mechanism 52 includes a cable end portion gripping portion 54, a cable end portion advancing and retracting driving portion 56, and a cable end portion conveyance driving portion 58.

The cable end portion gripping portion 54 is configured by an electromagnetic chuck that uses a solenoid, a chuck that uses an air cylinder, or the like, and includes a pair of openable and closable gripping pieces 54a. As a result of moving the pair of gripping pieces 54a in a closing direction, the cable end portion gripping portion 54 grips a portion of an end portion of the sheath 16 of the braid-shielded cable 10 that is located closer to the middle in the extending direction than a portion where the above-described exposed braid 14a is to be inverted.

The cable end portion advancing and retracting driving portion 56 is configured by a linear actuator such as an air cylinder, a hydraulic cylinder, or a linear motor, and advances and retracts the cable end portion gripping portion 54 toward and away from the braid raising mechanism 60, the shearing mechanism 80, and the inverting mechanism 100. That is to say, the braid raising mechanism 60, the shearing mechanism 80, and the inverting mechanism 100 are provided along one side of the cable end portion conveying mechanism 52, and the cable end portion advancing and retracting driving portion 56 drives the cable end portion gripping portion 54 so that the cable end portion gripping portion 54 moves between a retracted position at which the cable end portion gripping portion 54 is retracted from the braid raising mechanism 60, the shearing mechanism 80, and the inverting mechanism 100 and an advanced position at which the cable end portion gripping portion 54 is advanced to the braid raising mechanism 60 side, the shearing mechanism 80 side, and the inverting mechanism 100 side. In a state in which the cable end portion gripping portion 54 has been moved to the retracted position, the end portion of the braid-shielded cable 10 gripped by the cable end portion gripping portion 54 can be moved in the conveying direction P without interfering with the braid raising mechanism 60, the shearing mechanism 80, and the inverting mechanism 100. In a state in which the cable end portion gripping portion 54 has been moved to the advanced position, the end portion of the braid-shielded cable 10 gripped by the cable end portion gripping portion 54 is fed to a position at which the end portion can be processed by the braid raising mechanism 60, the shearing mechanism 80, or the inverting mechanism 100.

The cable end portion conveyance driving portion 58 is configured by a linear actuator such as an air cylinder, a hydraulic cylinder, or a linear motor, a feed mechanism that circulates an annular belt or an annular chain, or the like, and intermittently moves the cable end portion gripping portion 54 in the conveying direction P.

Here, two cable end portion gripping portions 54 are supported on a movable stage 59 via respective cable end portion advancing and retracting driving portions 56. In a state in which both end portions of a single braid-shielded cable 10 are separately gripped by the two cable end portion gripping portions 54, the end portions of the braid-shielded cable 10 can be successively and intermittently conveyed in the conveying direction P. At this time, the two cable end portion gripping portions 54 are supported on the movable stage 59 while being spaced apart from each other by a distance corresponding to the distance between processing positions of the braid raising mechanism 60, the shearing mechanism 80, and the inverting mechanism 100. Thus, while one of the end portions of the braid-shielded cable 10 gripped by a corresponding one of the cable end portion gripping portions 54 is being processed by one of the braid raising mechanism 60, the shearing mechanism 80, and the inverting mechanism 100, the other end portion of the braid-shielded cable 10, which is gripped by the other cable end portion gripping portion 54, can be processed at an adjacent processing position.

The end portions of the braid-shielded cable 10 conveyed by the cable end portion conveying mechanism 52 pass through and are processed by the braid raising mechanism 60, the shearing mechanism 80, and the inverting mechanism 100 in this order.

The braid raising mechanism 60 is configured to raise the exposed braid 14a from the stranded portion 12, which is the cable center portion, toward the outer circumferential side. Note that the stranded portion 12, in which the two insulated wires 13 are twisted together, may be untwisted at a portion where the exposed braid 14a is formed. Irrespective of whether or not the two insulated wires 13 exposed from the end portion of the sheath 16 are kept twisted together, the stranded portion 12 will be described as the cable center portion. The shearing mechanism 80 is configured to shear and thereby trim the leading end portion of the raised exposed braid 14a between an annular outer cutting edge 84b and an annular inner cutting edge 86b. The inverting mechanism 100 is configured to invert the trimmed exposed braid 14a so that the trimmed exposed braid 14a is folded onto the outer circumferential side (here, the outer circumferential side of the metal sleeve 18 externally fitted to the sheath 16) of the sheath 16. Since the leading end portion of the raised exposed braid 14a is trimmed by the shearing mechanism 80, the end portion of the exposed braid 14a can be trimmed as accurately as possible.

Note that the operations of the above-described various portions such as the cable end portion conveying mechanism 52, the braid raising mechanism 60, the shearing mechanism 80, and the inverting mechanism 100 are controlled by a control unit 51 configured by a microcomputer including a CPU, a ROM, a RAM, and the like and executing arithmetic processing according to a previously stored software program and predetermined set values.

Hereinafter, the configurations of the braid raising mechanism 60, the shearing mechanism 80, and the inverting mechanism 100 will be described.

### Braid Raising Mechanism

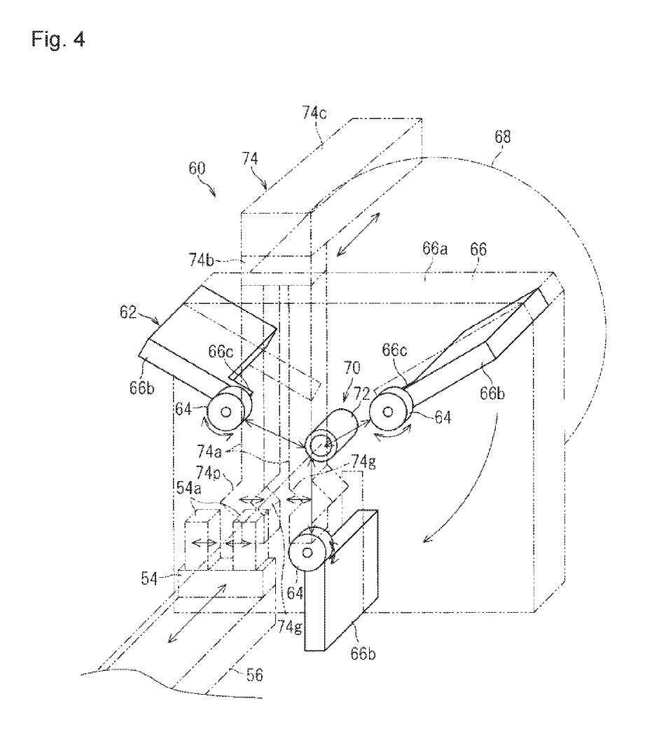

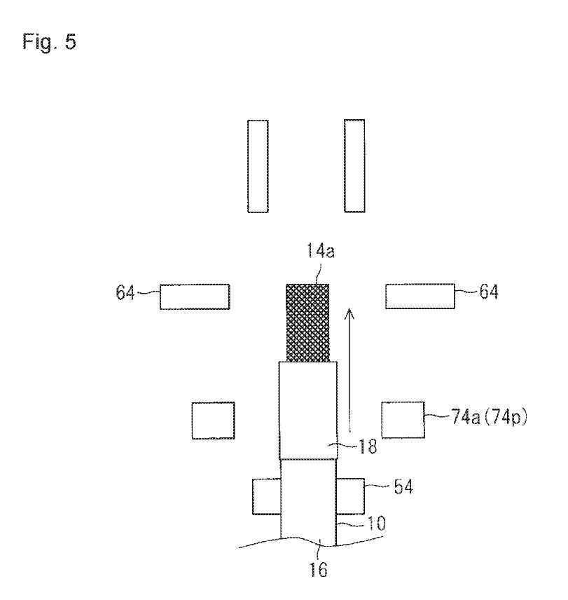

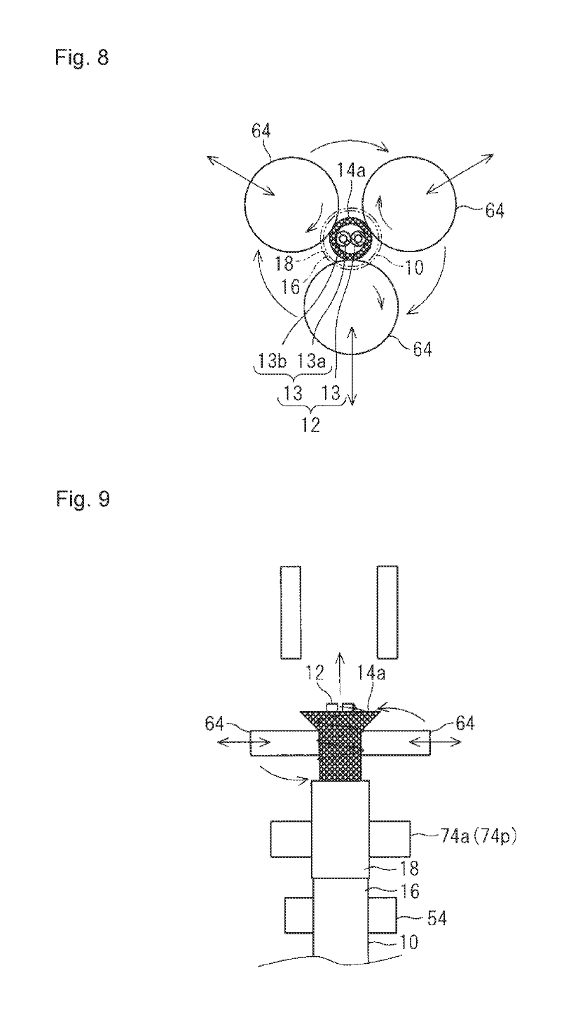

The braid raising mechanism 60 will be described. FIG. 4 is a schematic perspective view showing the braid raising mechanism 60, and FIGS. 5 to 12 are explanatory diagrams illustrating operations of the braid raising mechanism 60. FIGS. 5 to 7 and 9 to 12 each illustrate a positional relationship of relevant portions in a plan view, and FIG. 8 illustrates a positional relationship of relevant portions when viewed in an axial direction of the braid-shielded cable 10 that is to be processed.

The braid raising mechanism 60 is a mechanism for raising the exposed braid 14a from the stranded portion 12 toward the outer circumferential side, and includes a pressing and raising mechanism 62 and a sandwiching and raising mechanism 70.

A configuration is adopted in which when an end portion of the braid-shielded cable 10 that has been conveyed by the cable end portion conveying mechanism 52 is conveyed toward the braid raising mechanism 60, the pressing and raising mechanism 62 presses the exposed braid 14a from the outer circumferential side toward the stranded portion 12 and thereby raises the exposed braid 14a. The pressing and raising mechanism 62 raises the exposed braid 14a so that the exposed braid 14a gradually expands from the opening of the end portion of the sheath 16 toward the end portions of the insulated wires 13.

Subsequently, the sandwiching and raising mechanism 70 sandwiches the exposed braid 14a, which has been raised to a certain extent, on the outer circumferential side of the stranded portion 12 from both sides in the axial direction of the braid-shielded cable 10, thereby raising the exposed braid 14a to an approximately right angle to the axial direction of the braid-shielded cable 10. Thus, the exposed braid 14a is annually raised from the opening of the end portion of the sheath 16 to a direction that is as close to orthogonal to the axial direction of the braid-shielded cable 10 as possible.

Note that, in the description here, the positions of the cable end portion gripping portion 54 and the braid-shielded cable 10 are described using the position of the cable end portion gripping portion 54 when the braid-shielded cable 10 is fed toward the braid raising mechanism 60 and the position of the braid-shielded cable 10 held by the cable end portion gripping portion 54 at that time as the references.

More specifically, the pressing and raising mechanism 62 includes a rolling body 64, a rolling body contacting and separating mechanism 66, and a rolling body turning mechanism 68.

The rolling body 64 is made of a resin or the like and formed into a roller shape. Here, a plurality of (three, here) rolling bodies 64 are provided so as to surround the circumference of the exposed braid 14a at the end portion of the braid-shielded cable 10 that has been fed by the cable end portion conveying mechanism 52. The three rolling bodies 64 are provided at equal intervals around the central axis of the braid-shielded cable 10. Each rolling body 64 is supported by a rolling body support portion 66b of the rolling body contacting and separating mechanism 66, which will be described next, so as to be rotatable about an axis extending in the axial direction of the braid-shielded cable 10. The rolling bodies 64 may be spheres that are rotatably supported.

The rolling body contacting and separating mechanism 66 is configured to be capable of moving the rolling bodies 64 toward and away from the stranded portion 12.

More specifically, the rolling body contacting and separating mechanism 66 includes a driving main body portion 66a and the rolling body support portion 66b.

A plurality of (three, here) rolling body support portions 66b corresponding to the respective rolling bodies 64 are provided. Here, the rolling body support portions 66b are each formed into a plate-like shape, and one side portions thereof are supported by the driving main body portion 66a at equal intervals around the central axis of the braid-shielded cable 10. At each of the locations where the rolling body support portions 66b are supported, the rolling body support portion 66b is supported such that it extends in a radial direction of a circle around the central axis of the braid-shielded cable 10 and is also movable in the radial direction.

A support piece 66c extending toward the central axis of the braid-shielded cable 10 is formed at a position on the other side portion of each rolling body support portion 66b that is close to the central axis of the braid-shielded cable 10, and the rolling body 64 is rotatably supported by the support piece 66c.

The driving main body portion 66a is configured to be able to move the above-described rolling body support portions 66b in the radial direction of the circle around the central axis of the braid-shielded cable 10, toward and away from the central axis of the braid-shielded cable 10. As this driving main body portion 66a, a configuration in which a linear actuator, such as an air cylinder, a hydraulic cylinder, or a linear motor, is provided corresponding to each rolling body support portion 66b, and the rolling body support portions 66b are separately reciprocated by the respective linear actuators; a configuration in which driving force of an actuator such as an air cylinder, a hydraulic cylinder, or a linear motor or a rotary electric motor is transmitted to each rolling body support portion 66b via a transmission mechanism such as a gear, a linkage, or the like, and the rolling body support portions 66b are reciprocated in synchronization; and other configurations can be adopted.

The rolling body turning mechanism 68 includes a rotary electric motor or the like, and is secured in a fixed position relative to the device main body. The rolling body turning mechanism 68 supports a rear portion of the driving main body portion 66a. When the rolling body turning mechanism 68 is driven and rotated, the rolling body contacting and separating mechanism 66 rotates about the central axis of the braid-shielded cable 10. Thus, the rolling bodies 64 supported by the rolling body turning mechanism 68 also turn around the central axis of the braid-shielded cable 10, that is, around the stranded portion 12.

With the above-described pressing and raising mechanism 62, the rolling bodies 64 can rotate around the exposed braid 14a while pressing the exposed braid 14a. At this time, the cable end portion advancing and retracting driving portion 56 of the cable end portion conveying mechanism 52 moves the cable end portion gripping portion 54 toward the leading end side of the braid-shielded cable 10. Thus, the rolling bodies 64 relatively move from the leading end portion toward the base end portion of the exposed braid 14a. That is to say, the cable end portion advancing and retracting driving portion 56 operates as a moving mechanism that relatively moves the rolling bodies 64 from the leading end portion toward the base end portion of the exposed braid 14a when the rolling bodies 64 rotate around the exposed braid 14a while pressing the exposed braid 14a. It goes without saying that another moving mechanism may also be adopted which moves the above-described rolling bodies 64, together with the pressing and raising mechanism 62 and the like, in the axial direction of the braid-shielded cable 10 toward the base end portion side of the exposed braid 14a.

The sandwiching and raising mechanism 70 includes a raising annular member 72 and a raising annular receiving member 74p.

The raising annular member 72 enters between the stranded portion 12 and the exposed braid 14a and raises the exposed braid 14a. Here, the raising annular member 72 is configured by a metal pipe or the like, and is supported at a position that opposes the leading end portion of the braid-shielded cable 10. Here, the raising annular member 72 is supported on a portion of the driving main body portion 66a that opposes the leading end portion of the braid-shielded cable 10. A leading end portion of the raising annular member 72 is open toward the leading end portion of the braid-shielded cable 10. The central axis of the raising annular member 72 coincides with the central axis of the braid-shielded cable 10. The inner diameter of the raising annular member 72 is set to be equal to or larger than the outer diameter of a circumcircle that encloses the stranded portion 12, so that the stranded portion 12 can be inserted and disposed inside the raising annular member 72. Moreover, the inner diameter of the raising annular member 72 is set to be smaller than the outer diameter of the exposed braid 14a, which is raised by the above-described pressing and raising mechanism 62. Thus, when the braid-shielded cable 10 and the raising annular member 72 are relatively moved toward each other so that the stranded portion 12 is inserted and disposed in the raising annular member 72, the exposed braid 14a abuts against an end surface of the raising annular member 72 around an opening thereof and is raised to an even greater extent.

Moreover, a centering mechanism 74 is provided between the raising annular member 72 and the cable end portion gripping portion 54. The centering mechanism 74 includes a pair of centering support portions 74a, an opening and closing driving portion 74b, and an advancing and retracting driving portion 74c.

The pair of centering support portions 74a are formed into an elongated shape and supported by the opening and closing driving portion 74b in a suspended state so as to be openable and closable. Recesses 74g that are recessed outward in an open-close direction are formed in opposing portions of leading end portions of the pair of centering support portions 74a. Here, the recesses 74g are formed in a V-shaped groove shape. In a state in which the pair of centering support portions 74a are closed, the pair of recesses 74g constitute an annular portion 74p that surrounds the sheath 16 portion of the braid-shielded cable 10. This annular portion 74p is set to have such a size that the annular portion 74p surrounds the sheath 16 portion but does not clamp the sheath 16 (the annular portion 74p positions the central axis of the sheath 16 to a certain extent but does not inhibit movement in the axial direction). Thus, in a state in which the pair of centering support portions 74a are closed, while the annular portion 74p supports the sheath 16 of the braid-shielded cable 10 within a fixed range to a certain extent, the annular portion 74p can move along the sheath 16 of the braid-shielded cable 10.

The opening and closing driving portion 74b is configured by an electromagnetic chuck that uses a solenoid, a chuck that uses an air cylinder, or the like, and opens and closes the pair of centering support portions 74a.

The advancing and retracting driving portion 74c is configured by a linear actuator, such as an air cylinder, a hydraulic cylinder, or a linear motor, or the like, and reciprocates the opening and closing driving portion 74b and the pair of centering support portions 74a in the direction of the central axis of the braid-shielded cable 10.

Then, in a state in which the exposed braid 14a abuts against the end surface of the raising annular member 72 around the opening thereof, the annular portion 74p is moved toward the end surface of the raising annular member 72 around the opening thereof. Thus, the exposed braid 14a is sandwiched between the raising annular member 72 and the annular portion 74p on the outer circumferential side of the stranded portion 12. That is to say, the annular portion 74p has the function of the raising annular receiving member 74p.

The operations of the braid raising mechanism 60 will now be described.

First, in an initial state, as shown in FIG. 5, the rolling bodies 64 are located away from the central axis of the braid-shielded cable 10. In this state, either one end portion of the braid-shielded cable 10 is fed to the braid raising mechanism 60. That is to say, as a result of driving of the cable end portion advancing and retracting driving portion 56, the end portion of the braid-shielded cable 10 gripped by the cable end portion gripping portion 54 is fed toward a central portion between the plurality of rolling bodies 64. In a state immediately after the end portion of the braid-shielded cable 10 has been fed, in the axial direction of the braid-shielded cable 10, the rolling bodies 64 are arranged at positions where the rolling bodies 64 can abut against the leading end portion of the exposed braid 14a.

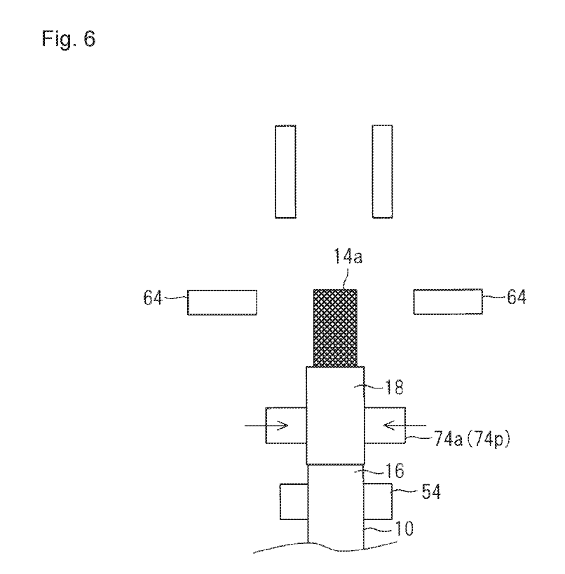

After that, as shown in FIG. 6, as a result of driving of the opening and closing driving portion 74b, the pair of centering support portions 74a are closed, and thus, the sheath 16 is surrounded by the annular portion 74p.

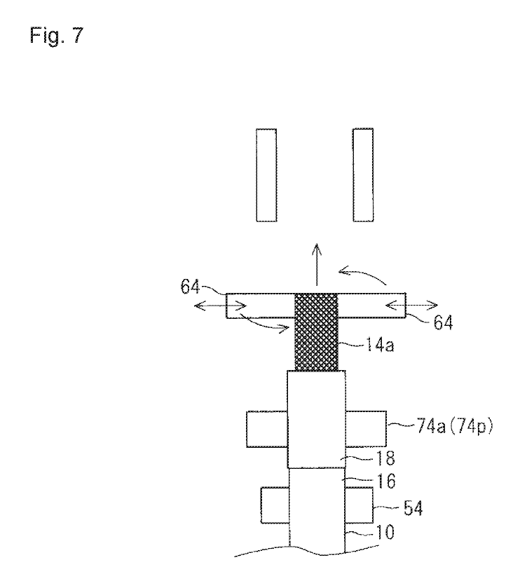

After that, as shown in FIGS. 7 and 8, as a result of driving of the driving main body portion 66a, the rolling bodies 64 are moved toward the exposed braid 14a and press the outer circumferential surface of the leading end portion of the exposed braid 14a. Thus, the plurality of rolling bodies 64 are arranged at equal intervals around the exposed braid 14a.

After that, as shown in FIGS. 7 to 9, the following three operations are simultaneously performed. The first operation is the operation of repeating an operation in which, as a result of driving of the driving main body portion 66a, the rolling bodies 64 are moved toward the exposed braid 14a, press the outer circumferential surface of the exposed braid 14a, and then move away from the exposed braid 14a. With this operation, the exposed braid 14a is pressed by each of the rolling bodies 64 a plurality of times. The second operation is the operation in which, as a result of driving of the rolling body turning mechanism 68, the rolling bodies 64 are rotated around the central axis of the braid-shielded cable 10. Thus, the rolling bodies 64 press the exposed braid 14a while rotating around the outer circumference of the exposed braid 14a. Even when the rolling bodies 64 are in contact with the exposed braid 14a, the rolling bodies 64 turn around the exposed braid 14a. However, since the rolling bodies 64 are supported so as to be rotatable about their axes extending in the axial direction of the braid-shielded cable 10, the rolling bodies 64 can be driven to rotate while coming into contact with an outer circumferential portion of the exposed braid 14a. Thus, torsional force or the like caused by the turning of the rolling bodies 64 is unlikely to be transmitted to the exposed braid 14a. The third operation is the operation of relatively moving the rolling bodies 64 from the leading end portion toward the base end portion of the exposed braid 14a. Here, as a result of driving of the cable end portion advancing and retracting driving portion 56, the cable end portion gripping portion 54 gripping the braid-shielded cable 10 is moved toward the leading end side of the braid-shielded cable 10, thereby relatively moving the rolling bodies 64 from the leading end portion toward the base end portion of the exposed braid 14a. Thus, the rolling bodies 64 intermittently press the outer circumferential surface of the exposed braid 14a while helically moving on the outer circumference of the exposed braid 14a from the leading end portion toward the base end portion of the exposed braid 14a.

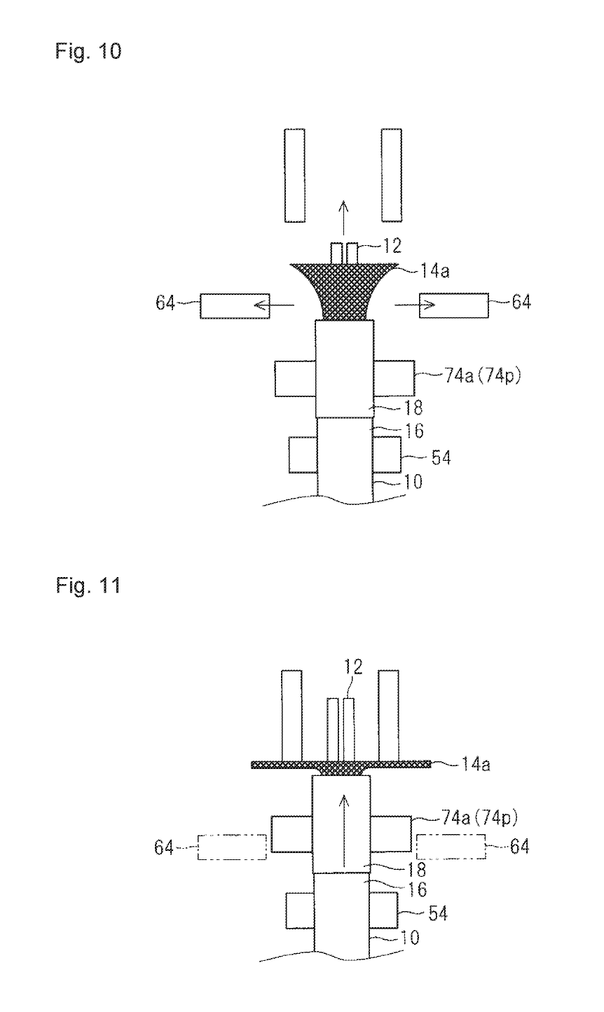

Thus, the exposed braid 14a is successively pressed by the rolling bodies 64 from the leading end portion toward the base end portion of the exposed braid 14a. A pressed portion of the exposed braid 14a is deformed so as to be depressed inward, but since the base end portion of the exposed braid 14a is fixed by the sheath 16, the leading end portion of the exposed braid 14a spreads so as to separate from the stranded portion 12. Since the exposed braid 14a is successively and helically pressed by the rolling bodies 64 from the leading end portion toward the base end portion of the exposed braid 14a, the exposed braid 14a consequently spreads into a trumpet shape, for example, so as to gradually expand toward the leading end side thereof as shown in FIG. 10. Thus, the exposed braid 14a is raised from the stranded portion 12 to a certain extent.

After that, as a result of driving of the driving main body portion 66a, the rolling bodies 64 are moved away from the exposed braid 14a. Then, as a result of driving of the cable end portion advancing and retracting driving portion 56, the cable end portion gripping portion 54 gripping the braid-shielded cable 10 is moved toward the raising annular member 72. Thus, as shown in FIG. 11, the stranded portion 12 is inserted into and disposed in the raising annular member 72, and the exposed braid 14a abuts against the end surface of the raising annular member 72 around the opening thereof and is raised to an even greater extent.

Note that the raising annular member 72 may also be moved toward the braid-shielded cable 10 that is supported in a fixed position.

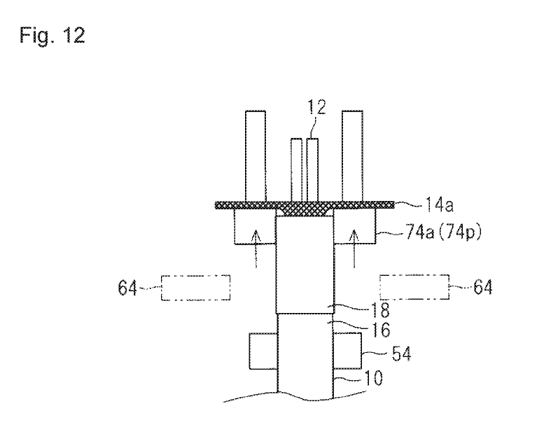

Next, as shown in FIG. 12, as a result of driving of the advancing and retracting driving portion 74c, the pair of centering support portions 74a are moved toward the raising annular member 72. Thus, the exposed braid 14a is sandwiched between the raising annular member 72 and the annular portion 74p, and the exposed braid 14a is raised to a position that is even closer to orthogonal to the axial direction of the braid-shielded cable 10.

Note that it is also possible to move the raising annular member 72 and the braid-shielded cable 10 so that the exposed braid 14a is sandwiched between the raising annular member 72 and the annular portion 74p.

The end portion of the braid-shielded cable 10 whose exposed braid 14a has been raised in this manner is conveyed toward the shearing mechanism 80 by the cable end portion conveying mechanism 52.

### Shearing Mechanism

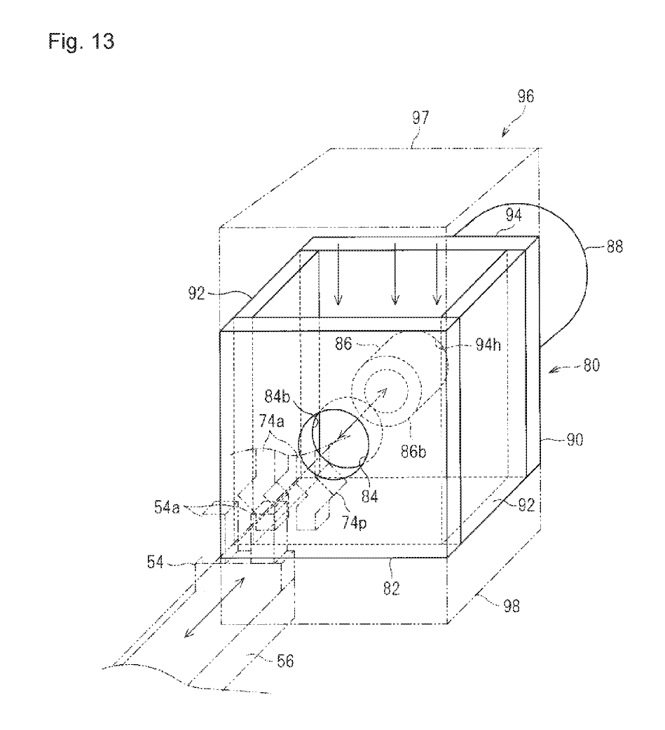

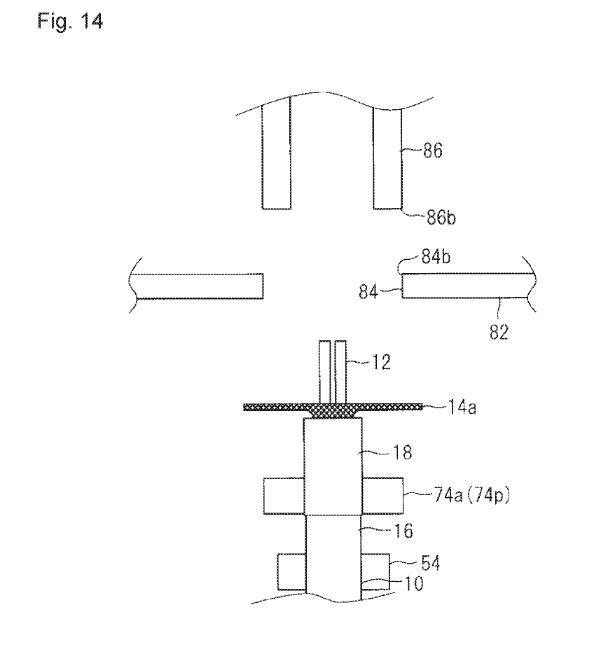

The shearing mechanism 80 will now be described. FIG. 13 is a schematic perspective view showing the shearing mechanism 80, and FIGS. 14 to 18 are explanatory diagrams illustrating operations of the shearing mechanism 80. FIGS. 14 to 18 each show a positional relationship of relevant portions in a plan view.

The shearing mechanism 80 includes an outer blade 82, an inner blade 86, and a blade driving portion 88.

When the exposed braid 14a at the end portion of the braid-shielded cable 10 that has been conveyed by the above-described cable end portion conveying mechanism 52 is annularly raised by the braid raising mechanism 60, the cable end portion conveying mechanism 52 conveys the end portion of the braid-shielded cable 10 toward the shearing mechanism 80.

Note that, in the description here, the positions of the cable end portion gripping portion 54 and the braid-shielded cable 10 are described using the position of the cable end portion gripping portion 54 when the braid-shielded cable 10 is conveyed toward the shearing mechanism 80 and the position of the braid-shielded cable 10 held by the cable end portion gripping portion 54 at that time as the references.

The annular outer cutting edge 84b having an inner diameter that is larger than the outer diameter of a circle that circumscribes the stranded portion 12 is formed on the outer blade 82. Moreover, the inner diameter of the annular outer cutting edge 84b is smaller than the outer diameter of the exposed braid 14a that is annularly raised toward the outer circumferential side of the braid-shielded cable 10. Here, the outer diameter of the exposed braid 14a that is annularly raised is, for example, a value obtained by adding the radius of the circle that circumscribes the stranded portion 12 (usually, the inner diameter of the sheath 16) and the length of the exposed braid 14a formed by stripping away the sheath 16 (the exposed length).

More specifically, the outer blade 82 is made of a metal or the like and is formed into a square plate shape, and a through hole 84 is formed in the outer blade 82 so as to penetrate the outer blade 82 from one surface side to the other surface side. An opening edge portion of the through hole 84 on one surface side, that is, the opening edge portion on the front side in the direction in which the braid-shielded cable 10 is inserted constitutes the annular outer cutting edge 84b.

The outer blade 82 need not be formed into a square plate shape, and may also be formed into an annular shape. However, when the outer blade 82 is formed into a square plate shape, the outer blade 82, together with a cover portion 90, which will be described later, can surround a portion to be sheared off.

The inner blade 86 has an insertion space into which the stranded portion 12 can be inserted, and the annular inner cutting edge 86b that can shear the leading end portion of the exposed braid 14a between itself and the annular outer cutting edge 84b is formed on an outer circumferential portion of the inner blade 86.

More specifically, the inner blade 86 is formed as a tubular member made of a metal or the like, and an opening end surface on one end portion side thereof is formed as a surface that is perpendicular to the central axis thereof. The inner blade 86 is formed to have an inner diameter that is larger than the outer diameter of a circle circumscribing the stranded portion 12, and an internal space of the inner blade 86 constitutes the insertion space into which the stranded portion 12 can be inserted.

Moreover, the outer diameter of the inner blade 86 is set to be equal to the inner diameter of the annular outer cutting edge 84b or smaller than the inner diameter of the annular outer cutting edge 84b by an amount corresponding to a gap that enables shearing of the exposed braid 14a between the annular outer cutting edge 84b and the inner blade 86. An outer circumferential edge portion of the opening of the inner blade 86 on one surface side thereof constitutes the annular outer cutting edge 84b.

The blade driving portion 88 relatively moves the inner blade 86 toward the annular outer cutting edge 84b, and herein moves the inner blade 86 toward the annular outer cutting edge 84b.

More specifically, the blade driving portion 88 is configured by a linear actuator, such as an air cylinder, a hydraulic cylinder, or a linear motor, and is provided on the side opposite to the cable end portion gripping portion 54 with respect to the outer blade 82.

A base end portion of the inner blade 86 is supported by the blade driving portion 88 so as to be able to be advanced and retracted in a reciprocating manner. More specifically, the inner blade 86 is supported so as to be able to be advanced and retracted on the side opposite to the cable end portion gripping portion 54 with respect to the outer blade 82 in a state in which the central axis of the inner blade 86 coincides with the central axis of the annular outer cutting edge 84b.

The end portion of the braid-shielded cable 10 is inserted into the through hole 84, and the annularly raised exposed braid 14a is disposed such that a main surface thereof on the base end side comes into contact with the annular outer cutting edge 84b around the stranded portion 12. In this state, as a result of driving of the blade driving portion 88, the inner blade 86 is moved toward the annular outer cutting edge 84b. Thus, the leading end portion of the annularly raised exposed braid 14a is sheared off between the annular outer cutting edge 84b and the annular inner cutting edge 86b. That is to say, a portion of the annularly raised exposed braid 14a that is located closer to the outer circumferential side than the annular outer cutting edge 84b is sheared off.

Note that although the inner blade 86 is moved by the blade driving portion 88 here, a moving mechanism that moves the outer blade 82 and the end portion of the braid-shielded cable 10 toward the inner blade 86 may also be adopted.

Moreover, in the present embodiment, the shearing mechanism 80 is provided with the cover portion 90 with which at least both lateral sides of the four sides of the portion to be sheared off of the exposed braid 14a are covered between the annular outer cutting edge 84b and the annular inner cutting edge 86b. Here, the cover portion 90 includes a pair of side wall portions 92 and an opposing wall portion 94. The pair of side wall portions 92 are square plate-shaped members made of a metal or the like, and extend from both side portions of the outer blade 82 toward a side on which the inner blade 86 is present. The opposing wall portion 94 is formed as a square plate-shaped member that is made of a metal or the like and that has a similar area to the outer blade 82, and blocks off a space between side portions of the pair of side wall portions 92 on the side opposite to the outer blade 82. A through hole 94h through which the inner blade 86 passes is formed in the opposing wall portion 94, and the inner blade 86 advances and retracts through the through hole 94h.

Thus, the portion to be sheared off of the exposed braid 14a is covered on all of the four sides by the outer blade 82 and the cover portion 90, which includes the pair of side wall portions 92 and the opposing wall portion 94. Therefore, a configuration is realized in which shear dust produced by performing shearing on the exposed braid 14a is unlikely to spread to the surrounding region. The portion to be sheared off need not be covered by the cover portion 90 on all four sides, but in order to make it unlikely that the shear dust will spread to an adjacent processing position, it is preferable to cover at least both lateral sides of the four sides of the portion to be sheared off. However, the cover portion 90 need not be provided.

Moreover, in the present embodiment, an air stream generating portion 96 that generates a stream of air within the cover portion 90 is provided. The air stream generating portion 96 includes an air supply portion 97 and an air discharge portion 98.

The air supply portion 97 is configured by an air compressor or the like, and is provided above the cover portion 90. The air supply portion 97 supplies air into the space covered by the cover portion 90 from above and generates a stream of air from the upper side toward the lower side within the space.

The air discharge portion 98 is configured by an air compressor or the like, and is provided above the cover portion 90. The air discharge portion 98 supplies air into the space covered by the cover portion 90 from above and generates a stream of air from the upper side toward the lower side within the space.

The air discharge portion 98 is configured by an air compressor or the like, and is provided below the cover portion 90. The air discharge portion 98 generates negative pressure below the space covered by the cover portion 90 and generates a stream of air from the upper side toward the lower side within the space.

Thus, the shear dust produced from the portion to be sheared off is guided downward by the air generated within the space covered by the cover portion 90, and is discharged to the outside.

The above-described air stream generating portion 96 need not be provided. Even if the air stream generating portion 96 is provided, it is not necessarily required that both of the air supply portion 97 and the air discharge portion 98 are provided, and only one of those portions may be provided.

Note that a centering mechanism similar to the above-described centering mechanism 74 is provided between the outer blade 82 and the cable end portion gripping portion 54. FIG. 13 shows a pair of centering support portions 74a.

The operations of the shearing mechanism 80 will now be described.

First, in an initial state, as shown in FIG. 14, the inner blade 86 is located away from the outer blade 82 on the side opposite to the cable end portion advancing and retracting driving portion 56 with respect to the outer blade 82. The cable end portion advancing and retracting driving portion 56 grips the end portion of the braid-shielded cable 10 whose exposed braid 14a has been annularly raised.

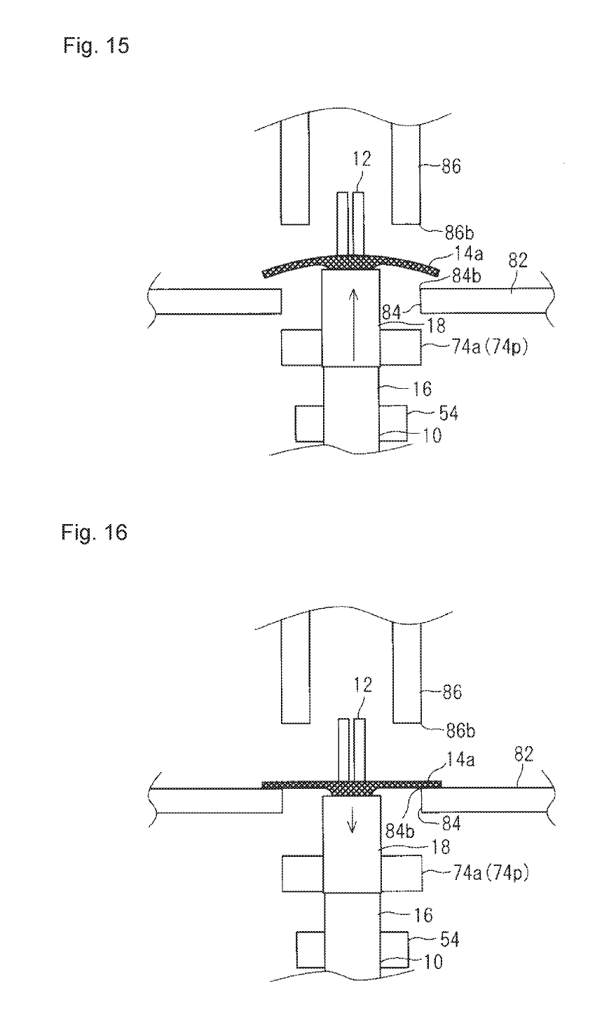

In this state, as shown in FIG. 15, either one end portion of the braid-shielded cable 10 is fed toward the shearing mechanism 80. That is to say, as a result of driving of the cable end portion advancing and retracting driving portion 56, the end portion of the braid-shielded cable 10 gripped by the cable end portion gripping portion 54 is fed toward the inside of the annular outer cutting edge 84b of the outer blade 82. Since the outer diameter of the annularly raised exposed braid 14a is larger than the inner diameter of the annular outer cutting edge 84b, the outer circumferential portion of the annularly raised exposed braid 14a passes through the through hole 84 of the outer blade 82 while coming into contact with an inner circumferential portion of the through hole 84. Therefore, the annularly raised exposed braid 14a may be bent backward toward the sheath 16 side. The braid-shielded cable 10 is fed until the annularly raised exposed braid 14a has moved past the annular outer cutting edge 84b.

Next, as shown in FIG. 16, as a result of driving of the cable end portion advancing and retracting driving portion 56, the end portion of the braid-shielded cable 10 gripped by the cable end portion gripping portion 54 is returned. At this time, the braid-shielded cable 10 is returned to such a position that the base end portion of the annularly raised exposed braid 14a is located on an extension of the surface of the outer blade 82 on the side where the annular outer cutting edge 84b is formed. Thus, an outer circumferential-side end portion of the annularly raised exposed braid 14a comes into contact with the surface of the outer blade 82 on the side where the annular outer cutting edge 84b is formed, on the outer circumferential side of the annular outer cutting edge 84b. Therefore, even if the annularly raised exposed braid 14a is bent backward toward the sheath 16 side, the annularly raised exposed braid 14a is returned so as to extend in a direction that is orthogonal to the axial direction of the braid-shielded cable 10 to a certain extent.

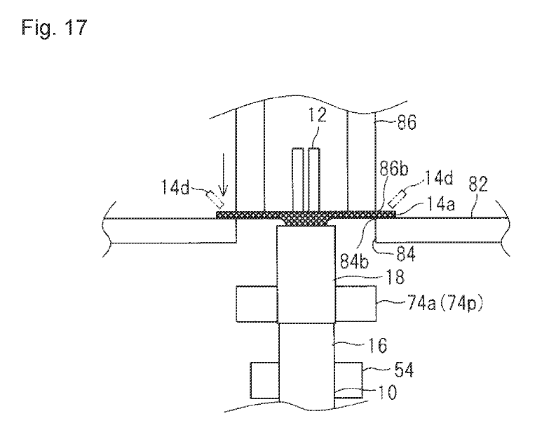

Then, as shown in FIG. 17, as a result of driving of the blade driving portion 88, the inner blade 86 is advanced. Thus, the leading end portion of the annularly raised exposed braid 14a is sheared off between the annular outer cutting edge 84b and the annular inner cutting edge 86b. Shear dust 14d is sent downward and discharged to the outside by the stream of air generated within the cover portion 90.

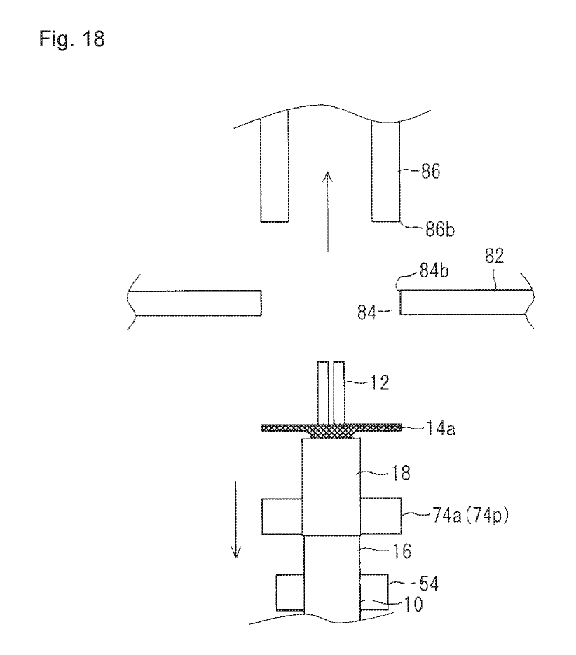

After that, as shown in FIG. 18, as a result of driving of the cable end portion advancing and retracting driving portion 56, the end portion of the braid-shielded cable 10 gripped by the cable end portion gripping portion 54 is returned so as to withdraw from the through hole 84. Moreover, as a result of driving of the blade driving portion 88, the inner blade 86 is moved so as to leave the annular outer cutting edge 84b. Thus, a braid-shielded cable 10 in which a leading end portion of the exposed braid 14a at an end portion of the braid-shielded cable 10 has been trimmed is produced.

This braid-shielded cable 10 is conveyed toward the inverting mechanism 100 by the cable end portion conveying mechanism 52.

### Inverting Mechanism

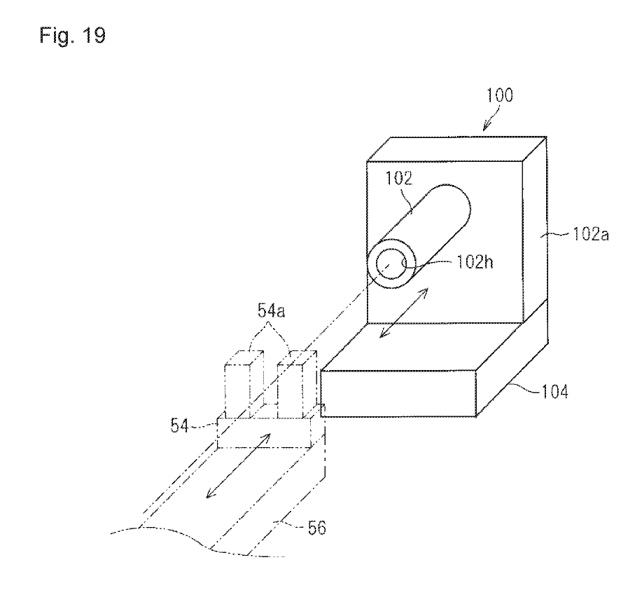

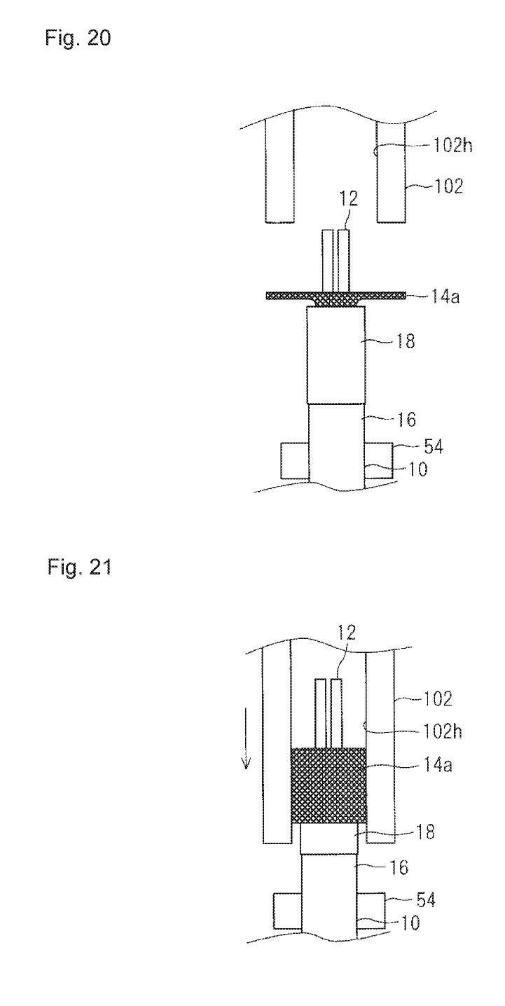

The inverting mechanism 100 will now be described. FIG. 19 is a schematic perspective view showing the inverting mechanism 100, and FIGS. 20 to 22 are explanatory diagrams illustrating operations of the inverting mechanism 100. FIGS. 20 to 22 each show a positional relationship of relevant portions in a plan view.

The inverting mechanism 100 is a mechanism for inverting the raised exposed braid 14a from the side opposite to the sheath 16 (i.e., from the end portion side of the braid-shielded cable 10) toward the outer circumferential side of the sheath 16.

After the leading end portion of the annularly raised exposed braid 14a at the end portion of the braid-shielded cable 10 has been trimmed by the shearing mechanism 80, the cable end portion conveying mechanism 52 conveys the end portion of the braid-shielded cable 10 toward the inverting mechanism 100.

Note that, in the description here, the positions of the cable end portion gripping portion 54 and the braid-shielded cable 10 are described using the position of the cable end portion gripping portion 54 when the braid-shielded cable 10 is conveyed toward the inverting mechanism 100 and the position of the braid-shielded cable 10 held by the cable end portion gripping portion 54 at that time as the references.

The inverting mechanism 100 includes an inverting member 102 in which an inverting hole 102h is formed. The inverting mechanism 100 is configured such that the stranded portion 12 exposed at the end portion of the braid-shielded cable 10 and the end portion (here, a portion covered with the metal sleeve 18) of the sheath 16 are inserted into the inverting hole 102h, and thus the raised exposed braid 14a can be pressed by a circumferential edge portion of an opening of the inverting hole 102h of the inverting member 102 and inverted toward the outer circumferential side of the end portion (here, the metal sleeve 18) of the sheath 16.

More specifically, the inverting mechanism 100 includes the inverting member 102 and an inverting member driving portion 104.

The inverting member 102 is formed as a member that has the inverting hole 102h into which the end portion (here, the metal sleeve 18) of the sheath 16 can be inserted. Here, the inverting member 102 is formed as a tubular member made of a metal or the like, and an end surface of the opening of the inverting member 102 on one end portion side thereof is formed as a surface that is perpendicular to the central axis thereof. The inner diameter of the inverting member 102 is set to be approximately a length obtained by adding the outer diameter of a portion of the braid-shielded cable 10 onto which the exposed braid 14a is to be inverted and double the thickness of the exposed braid 14a. The portion of the braid-shielded cable 10 onto which the exposed braid 14a is to be inverted is the above-described metal sleeve 18 if the metal sleeve 18 is attached, or the end portion of the sheath 16 if the metal sleeve 18 is not attached.

Although the inverting hole 102h is formed in a tubular member here, a configuration may also be adopted in which the inverting hole 102h is formed in a plate-shaped member or a block-shaped member.

The inverting member driving portion 104 relatively moves the inverting member driving portion 104 toward the braid-shielded cable 10, and herein moves the inverting member driving portion 104 toward the braid-shielded cable 10.

More specifically, the inverting member driving portion 104 is configured by a linear actuator, such as an air cylinder, a hydraulic cylinder, or a linear motor, and is provided at a position away from the end portion of the braid-shielded cable 10 supported by the cable end portion gripping portion 54.

The inverting member 102 is supported by a movable portion 102a that is driven to reciprocate by the inverting member driving portion 104. More specifically, the inverting member 102 is supported so as to be able to be advanced and retracted in a posture opposing the end portion of the braid-shielded cable 10 in a state in which the central axis of the inverting member 102 coincides with the central axis of the braid-shielded cable 10 supported by the cable end portion gripping portion 54.

Then, in a state in which the braid-shielded cable 10 is supported by the cable end portion gripping portion 54, the inverting member driving portion 104 advances the inverting member 102 toward the end portion of the braid-shielded cable 10. Thus, the stranded portion 12 at the end portion of the braid-shielded cable 10 and the end portion (here, including the metal sleeve 18) of the sheath 16 are inserted into the inverting hole 102h. At the same time, the annularly raised exposed braid 14a is pressed by the end surface of the opening of the inverting member 102 and inverted so as to cover the outer circumferential surface of the end portion (here, the metal sleeve 18) of the sheath 16.

Note that although the inverting member driving portion 104 moves the inverting member 102 here, a moving mechanism that moves the end portion of the braid-shielded cable 10 toward the inverting member 102 may also be adopted.

The cable end portion advancing and retracting driving portion 56 may be used as this moving mechanism.

The operation s of the inverting mechanism 100 will be more specifically described.

First, in an initial state, as shown in FIG. 20, the inverting member 102 is located away from the end portion of the braid-shielded cable 10 gripped by the cable end portion advancing and retracting driving portion 56.

In this state, as shown in FIG. 21, as a result of driving of the inverting member driving portion 104, the inverting member 102 is moved toward the end portion of the braid-shielded cable 10. Then, the stranded portion 12 at the end portion of the braid-shielded cable 10 and the end portion (here, including the metal sleeve 18) of the sheath 16 are inserted into the inverting hole 102h. The exposed braid 14a that has been raised from the stranded portion 12 toward the outer circumferential side and whose end portion has been sheared off is forced toward the outer circumferential side of the end portion (here, the metal sleeve 18) of the sheath 16 by the end surface of the inverting member 102, that is, the circumferential edge portion of the opening of the above-described inverting hole 102h. Thus, the exposed braid 14a is inverted so as to cover the outer circumferential side of the end portion (here, the metal sleeve 18) of the sheath 16.

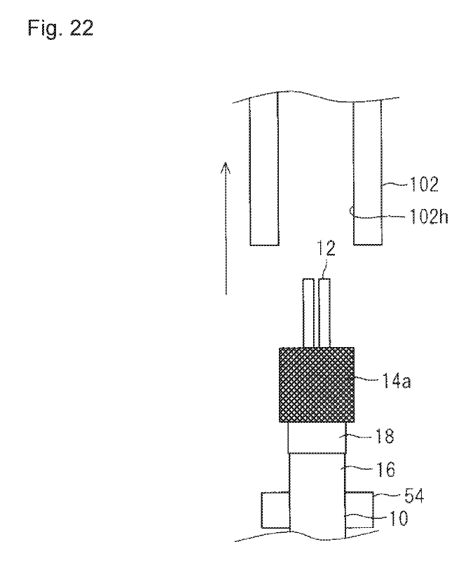

After that, as shown in FIG. 22, as a result of driving of the inverting member driving portion 104, the end portion of the braid-shielded cable 10 gripped by the cable end portion gripping portion 54 is returned so as to withdraw from the inverting hole 102h.

Thus, a braid-shielded cable 10 in which the exposed braid 14a at an end portion of the braid-shielded cable 10 is inverted so as to cover an end portion (here, the metal sleeve 18) of the sheath 16 is produced.

This braid-shielded cable 10 is conveyed toward a downstream stage by the cable end portion conveying mechanism 52, or is once discharged to the outside and subjected to a downstream step that is performed manually or the like.

Here, the exposed braid 14a is inverted onto the outer circumferential surface of the end portion (here, the metal sleeve 18) of the sheath 16, but this is not necessarily required. In the case where an internal insulating layer is provided on the cable center portion, the exposed braid 14a whose end portion has been trimmed may also be returned to the internal insulating layer side on the side opposite to the sheath 16, and the internal insulating layer be covered by the exposed braid 14a.

### Effects etc.

With the braid processing device configured as described above and the method for processing a braid-shielded cable, when the exposed braid 14a is raised from the stranded portion 12 toward the outer circumferential side, and the inner blade 86 is relatively moved toward the annular outer cutting edge 84b in a state in which one of the main surfaces of the exposed braid 14a is in contact with the annular outer cutting edge 84b around the stranded portion 12, the leading end portion of the exposed braid 14a is sheared off between the annular inner cutting edge 86b and the annular outer cutting edge 84b. Therefore, the end portion of the exposed braid 14a of the braid-shielded cable 10 can be trimmed as accurately as possible along the annular inner cutting edge 86b and the annular outer cutting edge 84b. Moreover, since the leading end portion of the exposed braid 14a is sheared off by the inner blade 86 and the outer blade 82, a relatively simple and inexpensive configuration can be realized.

Moreover, since the braid raising mechanism 60 includes the pressing and raising mechanism 62, which presses the exposed braid 14a from the outer circumferential side toward the stranded portion 12 and thereby raises the exposed braid 14a, it is easy to raise the exposed braid 14a even in the case where the exposed braid 14a extends along the outer circumferential surface of the stranded portion 12 and the gap therebetween is narrow.

Furthermore, since the pressing and raising mechanism 62 causes the rolling bodies 64 to turn around the stranded portion 12 while pressing the exposed braid 14a by moving the rolling bodies 64 toward the stranded portion 12, the exposed braid 14a can be effectively raised. In particular, the exposed braid 14a can be uniformly raised over the entire circumference thereof by turning the rolling bodies 64 around the stranded portion 12.

At this time, since the rolling bodies 64 are repeatedly moved toward and away from the stranded portion 12, the rolling bodies 64 can press the exposed braid 14a in a hitting fashion, and thus, the exposed braid 14a can be effectively raised.

Note that if a member that presses the exposed braid is turned around the exposed braid, a torsional force acts on the exposed braid, making the exposed braid untidy. In order to avoid this problem, it is conceivable to stop turning the member that presses the exposed braid when this member abuts against the exposed braid. However, in this case, the turning time is prolonged, and the period of time taken for the operation of raising the exposed braid is accordingly prolonged.

To address this issue, here, the exposed braid 14a is pressed by the rolling bodies 64. Thus, when a rolling body 64 presses the exposed braid 14a, the rolling bodies 64 can be driven to rotate while abutting against the exposed braid 14a. Therefore, pressing the exposed braid 14a with the rolling bodies 64 can be continued while continuously turning the rolling bodies 64 without stopping turning. This makes it possible to raise the exposed braid 14a in a short period of time.

Moreover, since the above-described rolling bodies 64 press the exposed braid 14a while relatively moving from the leading end portion toward the base end portion of the exposed braid 14a, a large region of the exposed braid 14a from the leading end portion to the base end portion thereof is raised, and thus, the exposed braid 14a is more reliably raised to a greater extent.

Moreover, the exposed braid 14a is raised from the stranded portion 12 using the raising annular member 72, and the exposed braid 14a is sandwiched between the raising annular member 72 and the raising annular receiving member 74p. Therefore, the exposed braid 14a can be even more reliably raised.

Moreover, since at least both lateral sides of the four sides of the portion to be sheared off by the annular outer cutting edge 84b and the annular inner cutting edge 86b are covered with the cover portion 90, the shear dust 14d is unlikely to spread to the surrounding region.

Furthermore, since the outer blade 82 in which the annular inner cutting edge 86b is formed surrounds the portion to be sheared off together with the above-described cover portion 90, the portion to be sheared off can be surrounded with a configuration that is as simple as possible.

Moreover, since the air stream generating portion 96 generates a stream of air in a portion surrounded by the cover portion 90, the shear dust 14d can be discharged by the air stream to a portion along the air stream, and thus, it is possible to make it unlikely that the shear dust 14d spreads to the surrounding region.

Moreover, with the inverting mechanism 100, the trimmed exposed braid 14a can be inverted so as to cover the outer circumferential side of the end portion (here, the metal sleeve 18) of the sheath 16.

Moreover, with the present device, the steps of trimming and inverting the end portion of the exposed braid 14a can be automatically performed.

### Modifications

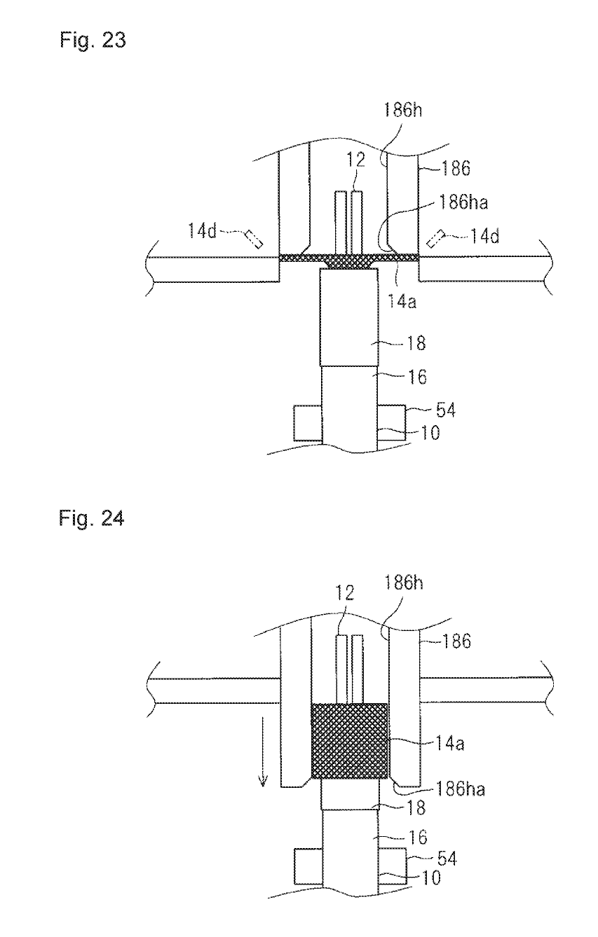

Note that although an example in which the inverting mechanism 100 is provided separately from the inner blade 86 has been described in the foregoing embodiment, it is also possible that, as shown in FIGS. 23 and 24, an inner blade 186 corresponding to the inner blade 86 inverts the exposed braid 14a.

The outer diameter of the aforementioned inner blade 186 is set to be similar to the outer diameter of the inner blade 86. The annular inner cutting edge 86b is formed at an outer circumferential edge portion of this inner blade 86 on one end side thereof.

An inverting hole 186h is formed in the inner blade 186. The inner diameter of this inverting hole 186h is set to be similar to the inner diameter of the inverting hole 102h of the inverting member 102. Preferably, a tapered circumferential surface 186ha is formed in an opening portion of the inverting hole 186h, the tapered circumferential surface 186ha gradually expanding toward the outside of the opening. With this tapered circumferential surface 186ha, the sheath 16, the metal sleeve 18, and the exposed braid 14a can be easily guided into the inverting hole 186h. The tapered circumferential surface 186ha may also be formed in the inverting hole 102h of the inverting member 102.

Then, as shown in FIG. 23, the inner blade 186 advances toward the annular outer cutting edge 84b, and the leading end portion of the exposed braid 14a is sheared off between the annular outer cutting edge 84b and the annular inner cutting edge 86b. After that, the inner blade 186 advances further. Thus, a leading end portion of the inner blade 186 presses the exposed braid 14a, which has been raised and trimmed, toward the outer circumferential side of the end portion (the metal sleeve 18) of the sheath 16. As a result, the exposed braid 14a is inverted so as to cover the outer circumferential side of the end portion (the metal sleeve 18) of the sheath 16.

In this manner, the trimmed exposed braid 14a can be inverted by the inner blade 186 so as to cover the outer circumferential side of the end portion (the metal sleeve 18) of the sheath 16, and therefore, simplification and the like of the device configuration can be achieved.

Moreover, although the braid raising mechanism 60 of the foregoing embodiment includes the pressing and raising mechanism 62 and the sandwiching and raising mechanism 70, a configuration may also be adopted in which the braid raising mechanism 60 includes only one of those mechanisms. Moreover, the pressing and raising mechanism 62 need not have the configuration in which the rolling bodies 64 are turned, and need not have the configuration in which the rolling bodies 64 are repeatedly moved toward and away from the exposed braid 14a so as to press the exposed braid 14a in a hitting fashion. The exposed braid 14a can also be raised to a certain extent with one of these configurations.

Moreover, although an example in which the leading end portion of the exposed braid 14a at the end portion of the braid-shielded cable 10 is trimmed has been described in the foregoing embodiment, even in the case where the braid is exposed at a middle portion of the braid-shielded cable 10 in the extending direction thereof, and one end portion of the exposed portion is cut from another portion of the braid, the exposed braid can be raised and the leading end portion thereof be trimmed in a manner similar to that described above. In this case, the above-described annular outer cutting edge, annular inner cutting edge, and the like can be formed at circumferential edge portions of penetrating holes.

Note that the configurations that have been described in the foregoing embodiments and modifications can be combined as appropriate unless they are inconsistent with one another.

Although the present invention has been described in detail above, the foregoing description is to be considered in all respects as illustrative, and the present invention is not limited to the foregoing description. It should be understood that innumerable modifications that are not described herein can be envisaged without departing from the scope of the present invention.

### LIST OF REFERENCE NUMERALS

10 Braid-shielded cable

12 Stranded portion

13 Insulated wire

14 Braid

14a Exposed braid

16 Sheath

18 Metal sleeve

50 Braid processing device

52 Cable end portion conveying mechanism

54 Cable end portion gripping portion

56 Cable end portion advancing and retracting driving portion

60 Braid raising mechanism

62 Pressing and raising mechanism

64 Rolling body

66 Rolling body contacting and separating mechanism

66a Driving main body portion

66b Rolling body support portion

68 Rolling body turning mechanism

70 Sandwiching and raising mechanism

72 Raising annular member

74 Centering mechanism

74a Centering support portion

74p Raising annular receiving member (annular portion)

80 Shearing mechanism

82 Outer blade

84b Annular outer cutting edge

86 Inner blade

86b Annular inner cutting edge

88 Blade driving portion

90 Cover portion

92 Side wall portion

94 Opposing wall portion

96 Air stream generating portion

100 Inverting mechanism

102 Inverting member

102h Inverting hole

104 Inverting member driving portion

186 Inner blade

186h Inverting hole

1. A braid processing device for trimming an end portion of an exposed braid of a braid-shielded cable including a cable center portion, a braid that covers an outer circumferential surface of the cable center portion, and a sheath that covers an outer circumferential surface of the braid, the exposed braid being exposed from the sheath, the braid processing device comprising:
a braid raising mechanism that raises the exposed braid from the cable center portion toward an outer circumferential side; and
a shearing mechanism including an outer blade that has an annular outer cutting edge having an inner diameter that is larger than an outer diameter of the cable center portion, an inner blade that has an insertion space into which the cable center portion can be inserted and that has an annular inner cutting edge on an outer circumferential portion thereof, the annular outer cutting edge and the annular inner cutting edge being capable of shearing the exposed braid therebetween, and a blade driving portion that relatively moves the inner blade toward the annular outer cutting edge in a condition state in which one of main surfaces of the exposed braid that has been raised from the cable center portion toward the outer circumferential side is in contact with the annular outer cutting edge around the cable center portion.

2. The braid processing device according to claim 1,
wherein the braid raising mechanism includes a pressing and raising mechanism that presses the exposed braid from the outer circumferential side toward the cable center portion and thereby raises the exposed braid.

3. The braid processing device according to claim 2,
wherein the pressing and raising mechanism includes a rolling body that is supported so as to be rotatable about an axis extending in an axial direction of the cable center portion, a rolling body contacting and separating mechanism that moves the rolling body toward and away from the cable center portion, and a rolling body turning mechanism that turns the rolling body around the cable center portion.

4. The braid processing device according to claim 3, comprising:
a moving mechanism that relatively moves the rolling body from a leading end portion toward a base end portion of the exposed braid in a condition in which the rolling body rotates while pressing the exposed braid.

5. The braid processing device according to claim 1,
wherein the braid raising mechanism includes a sandwiching and raising mechanism including a raising annular member that enters between the cable center portion and the exposed braid and raises the exposed braid and a raising annular receiving member that sandwiches the exposed braid between the raising annular receiving member and the raising annular member on the outer circumferential side of the cable center portion.

6. The braid processing device according to claim 1, comprising:
a cover portion that covers at least both lateral sides of four sides of a portion to be sheared off of the exposed braid between the annular outer cutting edge and the annular inner cutting edge.

7. The braid processing device according to claim 6,
wherein the outer blade surrounds the portion to be sheared off together with the cover portion.

8. The braid processing device according to claim 6, further comprising:
an air stream generating portion that generates a stream of air within the cover portion.

9. The braid processing device according to claim 1, further comprising:
an inverting mechanism including an inverting member in which an inverting hole into which the sheath can be inserted is formed, the inverting mechanism inverting the exposed braid that has been raised from the cable center portion toward the outer circumferential side and whose end portion has been sheared off, by forcing the exposed braid toward the outer circumferential side of the sheath using the inverting member.

10. The braid processing device according to claim 1,
wherein the inner blade inverts the exposed braid that has been raised from the cable center portion toward the outer circumferential side and whose end portion has been sheared off, by forcing the exposed braid toward the outer circumferential side of the sheath from a side opposite to the sheath.

11. A method for processing a braid-shielded cable using the braid processing device according to claim 1, the method comprising:
raising the exposed braid from the cable center portion toward the outer circumferential side using the braid raising mechanism; and
trimming the exposed braid by relatively moving the inner blade toward the annular outer cutting edge in a condition in which the outer blade is disposed so that the annular outer cutting edge is in contact with one of main surfaces of the exposed braid that has been raised from the cable center portion toward the outer circumferential side, around the cable center portion.
